(19) United States
(12) Patent Application Publication
(10) Pub. No.: US 2008/0311360 A1
(43) Pub. Date: Dec. 18, 2008

(54) Thick film circuit component and method for manufacturing the same

(75) Inventor: Yukihisa Kitagawa, Kamiina-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KOA CORPORATION, Ina-shi (JP)

(21) Appl. No.: 11/640,498

(22) Filed: Dec. 18, 2006

(51) Int. Cl. B32B 3/10; B32B 37/00

(52) U.S. Cl. 428/209; 156/60

(57) ABSTRACT

A thick film circuit component has a thick film electrode interconnect which allows an electrode on a semiconductor chip and an aluminum wire to be directly bonded to each other with a sufficient bonding strength. The thick film circuit component has an insulated substrate 11 and a thick film electrode interconnect 12 disposed on the substrate. The thick film electrode interconnect 12 includes a bonding area for an aluminum wire, the bonding area comprising an Ag-Pt thick film 12a disposed as a lower layer and an Ag-Pd thick film 12b disposed as an upper layer. The bonding area comprises the Ag-Pt thick film 12a and the Ag-Pd thick film 12b, which are fused together.

### BACKGROUND OF THE INVENTION

1. Field of the Invention

The present invention relates to a thick film circuit component such as a thick film hybrid IC component having at least a thick film electrode interconnect and a semiconductor chip on an insulated substrate made of alumina or the like, and a method for manufacturing the same.

2. Description of the Related Art

Heretofore, hybrid ICs have widely been used as thick film circuit components.

When a bare semiconductor chip is mounted on a hybrid IC, it is the general practice, as shown in FIG. 5, an aluminum wire 15 is bonded between an electrode 13a on a semiconductor chip 13 and a bonding pad 16 mounted on a portion of a thick film electrode interconnect 12 to each other. The bonding pad 16 comprises a thin plate of Cu, for example, and mounted in place by a separate mounting process after the thick film electrode interconnect 12 has been formed.

With the bonding pad 16 mounted on a portion of a thick film electrode, a space for the bonding pad 16 needs to be provided on an insulated substrate 11, limiting to reduce the size of the hybrid IC. It has been proposed to bond the aluminum wire 15 directly between the electrode 13a on the semiconductor chip and the thick film electrode interconnect 12 such as an Ag-Pd thick film. However, it has been pointed out that a direct connection achieved by an ordinary process fails to obtain a sufficient bonding strength and poses a reliability problem (see, for example, Japanese laid-open patent publication No. 6-244230).

### SUMMARY OF THE INVENTION

It is an object of the present invention to provide a thick film circuit component having a thick film electrode interconnect which allows an aluminum wire to be directly bonded between an electrode on a semiconductor chip and the thick film electrode interconnect with a sufficient bonding strength.

To accomplish the above object, there is provided in accordance with the present invention a thick film circuit component comprising an insulated substrate and a thick film electrode interconnect disposed on the substrate, wherein the thick film electrode interconnect includes a bonding area for an aluminum wire, the bonding area comprising an Ag-Pt thick film disposed as a lower layer and an Ag-Pd thick film disposed as an upper layer. The bonding area comprises the Ag-Pt thick film and the Ag-Pd thick film superposed one on the other, which are fused together.

According to the present invention, a dense double-layer electrically conductive thick film is provided, because it is made up of the Ag-Pt thick film and the Ag-Pd thick film superposed one on the other. When an aluminum wire is bonded to the double-layer electrically conductive thick film, a sufficient bonding strength is achieved. So, there is no need to mount a conventional bonding pad in the form of a thin plate of Cu. Therefore, the thick film circuit component is capable of high-density packaging, is reduced in size, and can be fabricated according to a simplified production process.

### BRIEF DESCRIPTION OF THE DRAWINGS

FIG. 1 is a fragmentary cross-sectional view of a thick film circuit component according to an embodiment of the present invention;

FIG. 2 is a graph showing a comparison between a thick film electrode interconnect according to the present invention and conventional thick film electrode interconnects;

FIG. 3A is an enlarged diagram showing a scanning electron microscope photographic representation of a surface of a single-layer structure of an Ag-Pt thick film;

FIG. 3B is an enlarged diagram showing a scanning electron microscope photographic representation of a cross section of the single-layer structure of the Ag-Pt thick film;

FIG. 3C is an enlarged diagram showing a scanning electron microscope photographic representation of a surface of a single-layer structure of an Ag-Pd thick film;

FIG. 3D is an enlarged diagram showing a scanning electron microscope photographic representation of a cross section of the single-layer structure of the Ag-Pd thick film;

FIG. 3E is an enlarged diagram showing a scanning electron microscope photographic representation of a surface of a laminated structure of an Ag-Pt thick film and an Ag-Pd thick film;

FIG. 3F is an enlarged diagram showing a scanning electron microscope photographic representation of a cross section of the laminated structure of the Ag-Pt thick film and the Ag-Pd thick film;

FIG. 4 is a flowchart showing an example of a process for fabricating a hybrid IC according to the present invention; and

FIG. 5 is a fragmentary cross-sectional view of a conventional thick film circuit component.

### DETAILED DESCRIPTION OF THE PREFERRED EMBODIMENT

An embodiment of the present invention will be described below with reference to the accompanying drawings. Parts or elements having identical functions are denoted by identical reference characters throughout views.

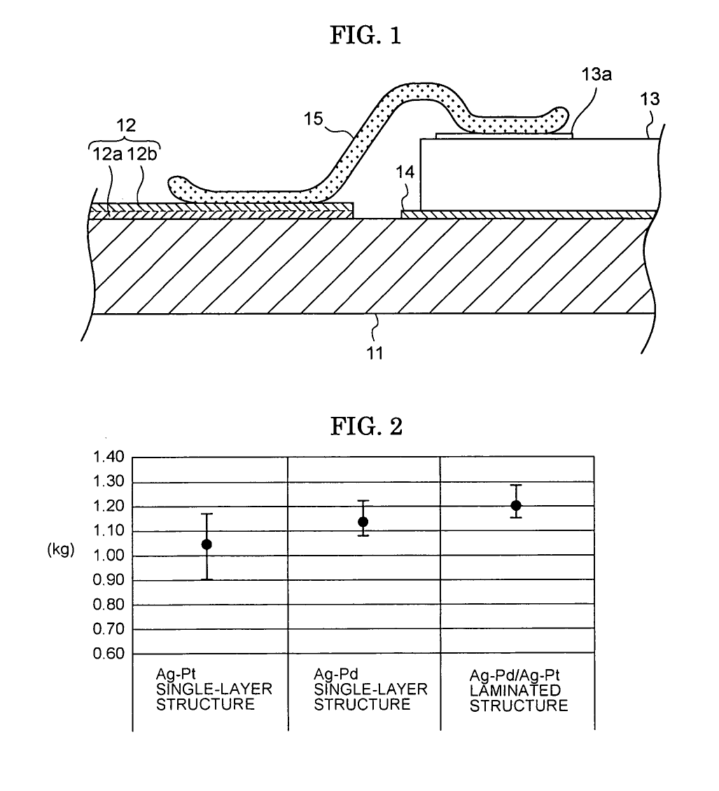

FIG. 1 shows a bonding area of a thick film circuit component according to an embodiment of the present invention. A thick film electrode interconnect 12 is disposed on the surface of an insulated substrate 11 made of alumina or the like. The thick film electrode interconnect comprises a laminated structure of an Ag-Pt thick film 12a as a lower layer and an Ag-Pd thick film 12b as an upper layer. For example, each of these layers has a thickness of about 12 μm, resulting in a total thickness of about 24 μm. The thick film electrode interconnect 12 has a width ranging from 500 to 600 sum, for example, which is about one half of the width of the conventional bonding pad 16 in the form of a thin plate of Cu or the like.

The thick film circuit component comprises a hybrid IC having a semiconductor chip (bare chip) 13 mounted in place as an active element and resistive and capacitive elements (not shown) mounted in place as passive elements. The semiconductor chip 13 is fixedly mounted on a land 14 on the insulated substrate 11 by an electrically conductive adhesive or the like.

An aluminum wire 15 has its opposite ends bonded respectively to an electrode 13a on the semiconductor chip 13 and a bonding area of the thick film electrode interconnect 12, so that the semiconductor chip 13 and the thick film electrode interconnect 12 are connected to each other by the aluminum wire 15. The aluminum wire 15 is bonded by 15 ultrasonic bonding method to provide good bonding to the electrode 13 on the semiconductor chip and good bonding to the bonding area of the thick film electrode interconnect 12.

FIG. 2 shows a comparison as to bonding strengths of a laminated structure of an Ag-Pt thick film and an Ag-Pd thick film according to the present invention, a single-layer structure of an Ag-Pt thick film, and a single-layer structure of an Ag-Pd thick film. As shown, the single-layer structure of the Ag-Pt thick film has an overall low bonding strength and suffers variations of the bonding strength. The bonding strength of the single-layer structure of the Ag-Pd thick film is improved over the single-layer structure of the Ag-Pt thick film, but is not sufficient.

Compared with these single-layer structures, the laminated structure of the Ag-Pt thick film and the Ag-Pd thick film provides a bonding strength equivalent to the bonding strength of the conventional structure with the bonding pad shown in FIG. 5.

Consequently, the conventional bonding pad 16 can be dispensed with, and a portion of the thick film electrode interconnect 12 can be used as a bonding area for the aluminum wire. If a portion of the thick film electrode interconnect 12 is used as a bonding area for the aluminum wire, then the area required by the conventional bonding pad 16 may be reduce to about one half, increasing the packaging density and reducing the overall dimensions of the thick film hybrid IC. Since there is no need to mount the conventional bonding pad 16, the production process is simplified and the man-hours required for producing the thick film circuit component are reduced.

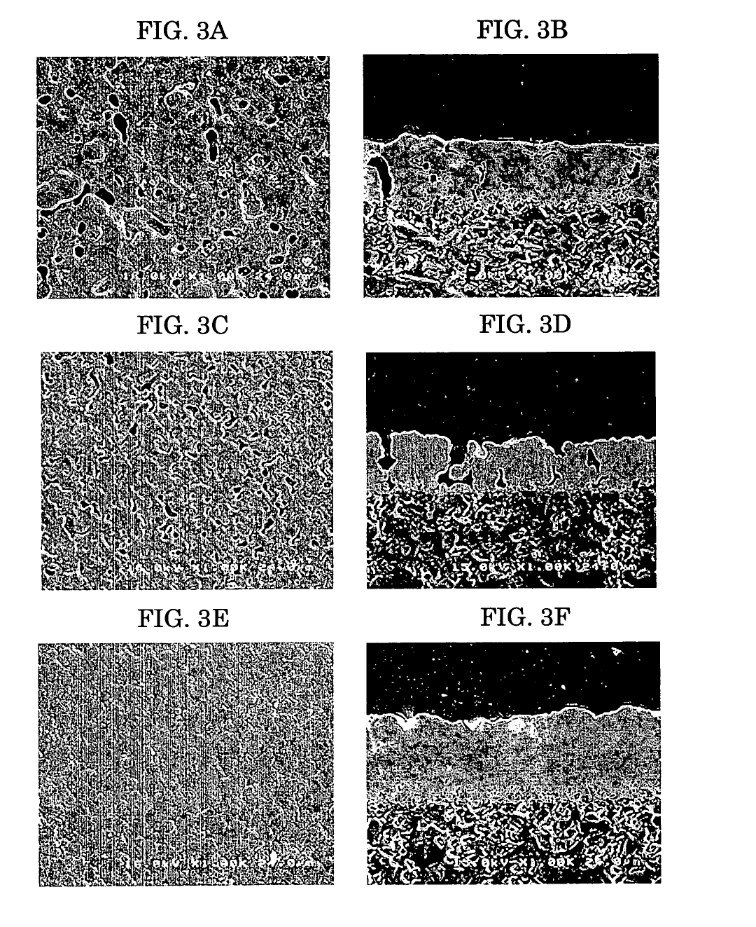

FIGS. 3A through 3F are enlarged diagrams of 1000-magnification scanning electron microscope photographic representations of surfaces and cross sections of the single-layer structure of the Ag-Pt thick film, the single-layer structure of the Ag-Pd thick film, and the laminated structure of the Ag-Pt thick film and the Ag-Pd thick film. As shown, the single-layer structure of the Ag-Pt thick film (FIGS. 3A, 3B) and the single-layer structure of the Ag-Pd thick film (FIGS. 3C, 3D) have thick films formed as coarse layers. Compared with these single-layer structures, the laminated structure of the Ag-Pt thick film and the Ag-Pd thick film (FIGS. 3E, 3F) has a thick film formed as a dense layer. Since the thick film is formed as a dense layer, it provides a good bonding strength for the aluminum wire.

As shown in FIG. 3F, when the laminated structure of the Ag-Pt thick film and the Ag-Pd thick film is burned, the Ag-Pt thick film and the Ag-Pd thick film are fused together into a dense film. Though the Ag-Pt thick film 12a as the lower layer has a low resistivity value and exhibits good adhesion to the alumina substrate 11, it is more likely to leach in contact with solder. The Ag-Pd thick film 12b as the upper layer is less liable to leach in contact with solder though it has a rather high resistivity value. When the Ag-Pt thick film 12a and the Ag-Pd thick film 12b are fused together, they form a thick film having a good bonding capability without impairing the properties of the electrically conductive thick film electrode such as adhesion to the substrate, etc.

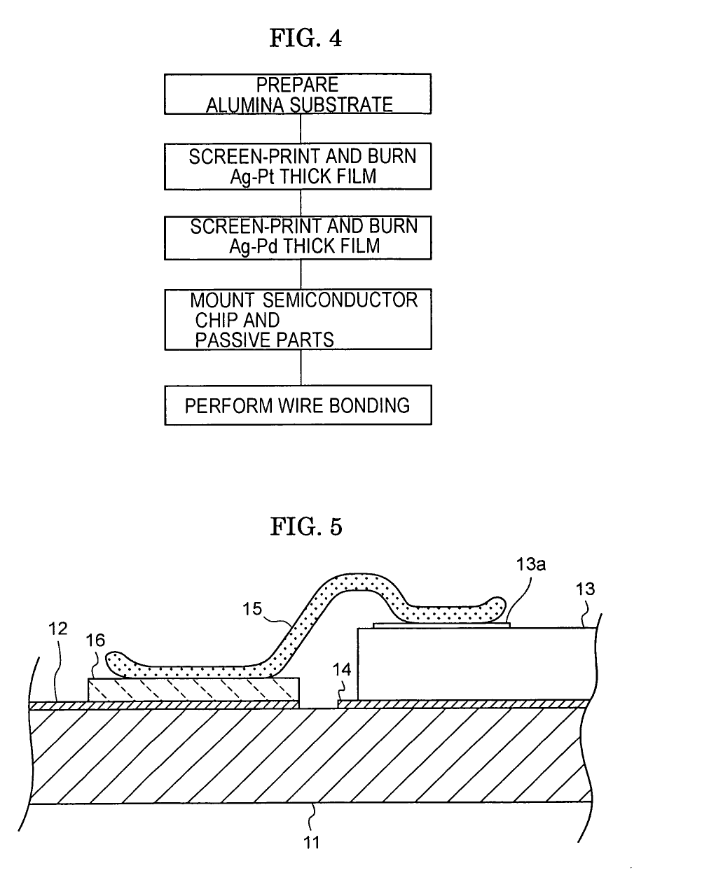

FIG. 4 shows an example of a process for fabricating a hybrid IC. First, an alumina substrate is prepared. Then, an Ag-Pt thick film paste is applied to the alumina substrate by screen-printing. After the Ag-Pt thick film paste is dried, it is burned into an electrode interconnect layer in the form of an Ag-Pt thick film. Then, an Ag-Pd thick film paste is applied in superposed relation to the Ag-Pt thick film electrode interconnect pattern by screen-printing. After the Ag-Pd thick film paste is dried, it is burned into an electrode interconnect layer in the form of an Ag-Pd thick film. Though the superposed printing may be performed on the entire thick film electrode interconnect pattern, it may be performed only on the bonding area of the thick film electrode interconnect pattern for the aluminum wire. The partial superposed printing is effective to reduce the amount used of the expensive Ag-Pd thick film paste.

Then, the semiconductor chip and passive parts such as chip resistors, chip capacitors, etc. are mounted in place by electrically conductive adhesive bonding or reflow soldering. The aluminum wire is then ultrasonically bonded to the electrode on the semiconductor chip and the bonding area of the thick film electrode interconnect, and hence is connected in position. In this manner, it is possible to fabricate a thick film hybrid IC which does not require a bonding pad in the form of a conventional thin plate of Cu, and it is capable to fabricate a thick film hybrid IC of high-density packaging.

According to the superposed printing described above, after the Ag-Pt thick film paste has been printed and burned, the Ag-Pd thick film paste is printed in superposed relation to the Ag-Pt thick film electrode pattern and then burned. However, after the Ag-Pt thick film paste has been printed and dried, the Ag-Pd thick film paste may be printed in superposed relation to the Ag-Pt thick film paste and dried, and thereafter the Ag-Pt thick film paste and the Ag-Pd thick film paste may be burned simultaneously.

The hybrid IC has been described in the above embodiment. However, the present invention is also applicable to thick film circuit components of other types wherein aluminum wires are used for bonding.

Although an embodiment of the present invention has been described above, it is obvious that the present invention is not limited to the above embodiment, but may take various different forms and configurations within the scope of the technical concepts thereof.

What is claimed is:

1. A thick film circuit component comprising an insulated substrate and a thick film electrode interconnect disposed on the substrate,
wherein said thick film electrode interconnect includes a bonding area for an aluminum wire, said bonding area comprising an Ag-Pt thick film disposed as a lower layer and an Ag-Pd thick film disposed as an upper layer, which are superposed one on the other.

2. The thick film circuit component according to claim 1, wherein said bonding area comprises the Ag-Pt thick film and the Ag-Pd thick film which are fused together.

3. A method of manufacturing a thick film circuit component, comprising:
preparing an insulated substrate;
placing an electrode interconnect layer in a form of an Ag-Pt thick film on said insulated substrate; and
placing an electrode interconnect layer in a form of an Ag-Pd thick film in superposed relation to the electrode interconnect layer in the form of the Ag-Pt thick film.

4. The method according to claim 3, wherein said electrode interconnect layer in the form of the Ag-Pd thick film is disposed in superposed relation to the electrode interconnect layer in the form of the Ag-Pt thick film only in a bonding area for an aluminum wire.
